(19) United States
(12) Patent Application Publication
(10) Pub. No.: US 2009/0001763 A1
(43) Pub. Date: Jan. 1, 2009

(54) Mounting Process and Mounting Unit for Doors on Vehicle Bodies

(76) Inventors: Bruno Emerich, Augsburg (DE); Johann Hesse, Augsburg (DE); Thomas Kollmar, Flein (DE)

Correspondence Address: MCGLEW & TUTTLE, PC, P.O. BOX 9227, SCARBOROUGH STATION, SCARBOROUGH, NY, 10510-9227, US

(21) Appl. No.: 12/096,942

(22) PCT Filed: Dec. 13, 2006
(86) PCT No.: PCT/EP2006/011979

§ 371 Date: Jun. 11, 2008

(30) Foreign Application Priority Data
Dec. 13, 2005 (DE) 20 2005 019 619.3

(51) Int. Cl. B62D 65/06

(52) U.S. Cl. 296/202; 901/31

(57) ABSTRACT

The invention relates to a method and a system for mounting at least four lateral doors (6, 7, 8, 9) on a vehicle body (5) comprising door holes (30, 31). Several lateral doors (6, 7, 8, 9) are mounted jointly on one side of the vehicle in an assembly station (2, 3) and are jointly retained, measured, and aligned by a positioning mechanism (13) encompassing a measuring and aligning device (17). Preferably, the door is fastened from the inside of the body by means of a fastening device (19) located on the opposite side of the vehicle.

### CROSS REFERENCE TO RELATED APPLICATIONS

This application is a U.S. National Phase application of International Application PCT/EP2006/011979 and claims the benefit of priority under 35 U.S.C. § 119 of German patent application DE 20 2005 019 619.3 filed Dec. 13, 2005, the entire contents of which are incorporated herein by reference.

### FIELD OF THE INVENTION

The present invention pertains to a mounting process and a mounting unit for the mounting of at least four side doors on a vehicle body.

### BACKGROUND OF THE INVENTION

It is known and common in practice to mount the front side doors in pairs on the left and right and subsequently the rear side doors in pairs on the left and right on the vehicle body in the case of four-door vehicle bodies, and this order may also be reversed. As a result, the front and rear side doors are mounted offset in time on each side of the vehicle. This has proved to be insufficient in respect to the increasing quality requirements imposed on the optical appearance of vehicles.

### SUMMARY OF THE INVENTION

The object of the present invention is to show a better mounting technique.

The mounting technique according to the invention has the advantage that on each side of the vehicle, the side doors located there can be mounted together and in a mutually coordinated manner with one another and with the vehicle body. Due to the possibility of mutual alignment, better and more uniform appearance of the vehicle can be achieved. Visible gaps and other design lines can be presented in an optimal form. In addition, suitable allowances can be taken into account for the later final mounting of the finished and heavier doors in an accurately fitting manner in the case of the initial mounting of the still bare side doors.

The mounting of the doors from the interior space of the body with a corresponding, suitable fixing means has the advantage that fixation of the side doors, preferably provided with door hinges in advance, can be carried out in the closed position in the door cutout of the vehicle body. This is the position of the door that is determined by the positioning means and is decisive for the optical appearance of the finished vehicle. The mounting technique being claimed also offers here especially suitable embodiments of the door hinge with bent hinge flanges and with body parts intended for the fixation, especially the door pillars. The outside mounting of the hinge flanges on the door pillars is especially suitable and facilitates fixation from the interior space of the body.

It is, furthermore, favorable in the case of the mounting technique being claimed that the positioning and fixing means, which preferably comprise robots each, can be arranged such that they do not mutually hinder each other. It is especially advantageous for this if the fixing robots are arranged on the other side of the vehicle and extend with their fixing tools, e.g., screwing or welding tools, through the adjacent door cutout or possibly the window cutout of an already mounted side door into the interior space of the body and reach the fixing sites of the side doors to be mounted, which said fixing sites are located opposite.

With the mounting technique of the invention, two or more side doors are mounted on one side of the vehicle in a first mounting station and the side doors of the other side of the vehicle are subsequently mounted in an optionally other mounting station. The mounting operations performed side by side may also be carried out within a single mounting station with positioning and fixing means functioning in a correspondingly flexible manner. The side-by-side door mounting and the possibility of setting up the positioning and fixing robots in a trouble-free manner offers, furthermore, the possibility of mounting additional body parts, e.g., fenders or the like, on the same side of the vehicle within one mounting station.

The premounting of door hinges on the side doors has the advantage that any tolerances on the body parts can be better absorbed and compensated. By means of the measuring and aligning device used for the correctly fitting positioning of the door, or another measuring device, it is possible to check during and after the mounting of the door whether the premounting of the door hinges on the side door was correct and whether the existing tolerances were absorbed correctly. If deviations are detected in this connection and a trend is seen in the development of the tolerances on the basis of a statistical survey and analysis, this can be counteracted for the subsequent doors in a specific manner by a corresponding feedback to the premounting unit and a corresponding precompensation of the dimensional imperfections detected.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a schematic top view of a mounting unit with a plurality of mounting stations for the side-by-side mounting of side doors on a vehicle body;

FIG. 2 is a perspective view of a mounting station with positioning and fixing means arranged opposite at the vehicle body;

FIG. 3 is a top view of the mounting station according to FIG. 2;

FIG. 4 is a side view of the vehicle body with gripping tools without robots according to arrow IV in FIG. 3;

FIG. 5 is a top view of a door with a door hinge in the aligned position; and

FIG. 6 is a top view of a door with a door hinge in the aligned and mounting position.

### DESCRIPTION OF THE PREFERRED EMBODIMENTS

Referring to the drawings in particular, the present invention pertains to a mounting technique for the side-by-side mounting of side doors (6, 7, 8, 9) on a vehicle body (5). This pertains specifically to the mounting unit (1) provided herefor and, further, also to the 15 mounting process as well as the correct design of the vehicle parts, especially the vehicle body (5), the side doors (6, 7, 8, 9) and the door hinges (34) for the mounting.

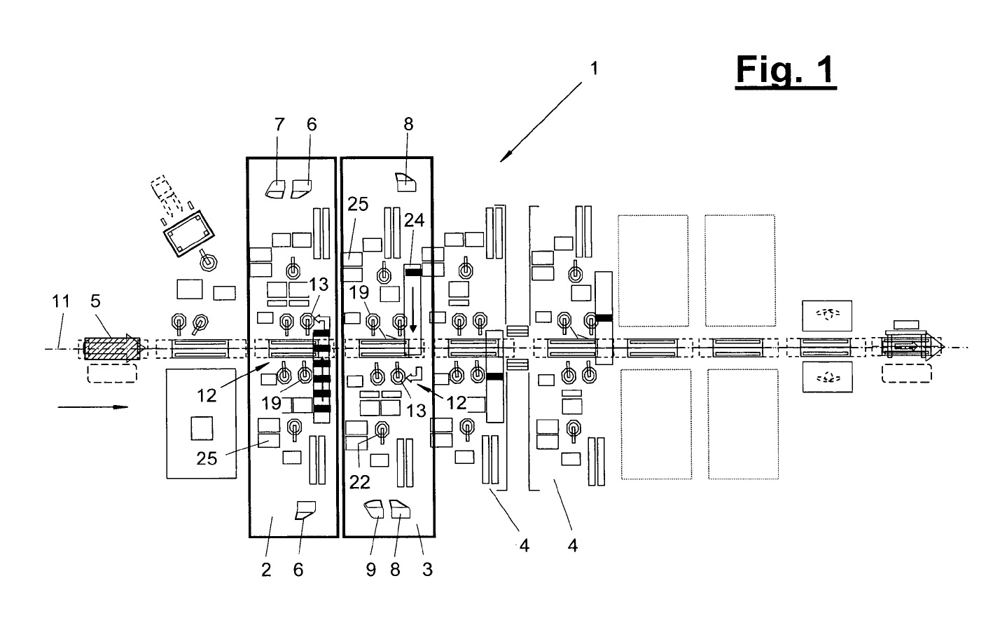

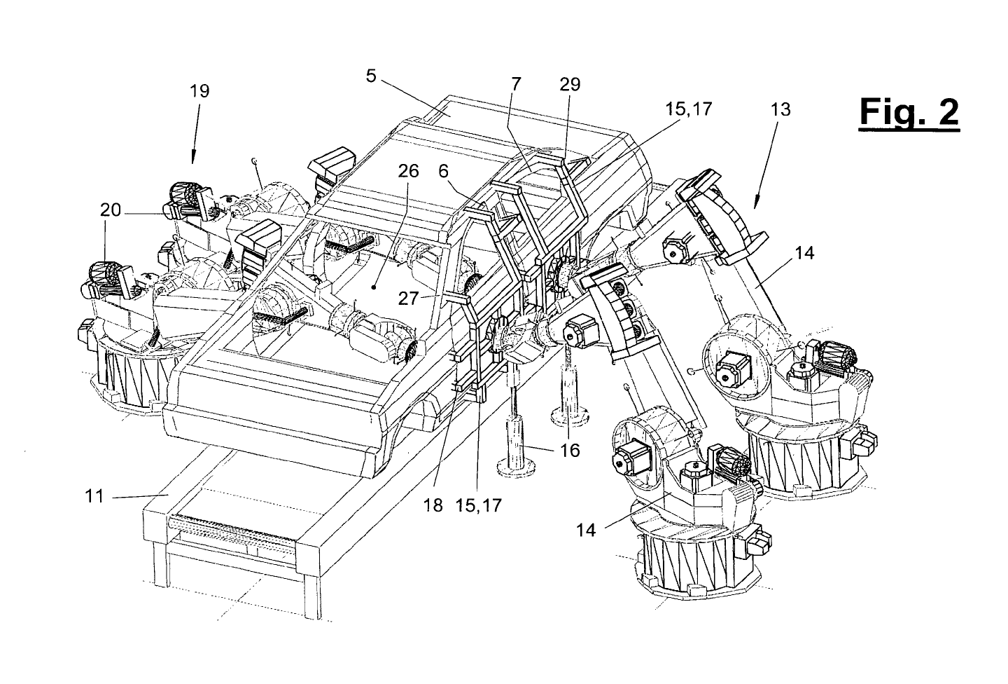

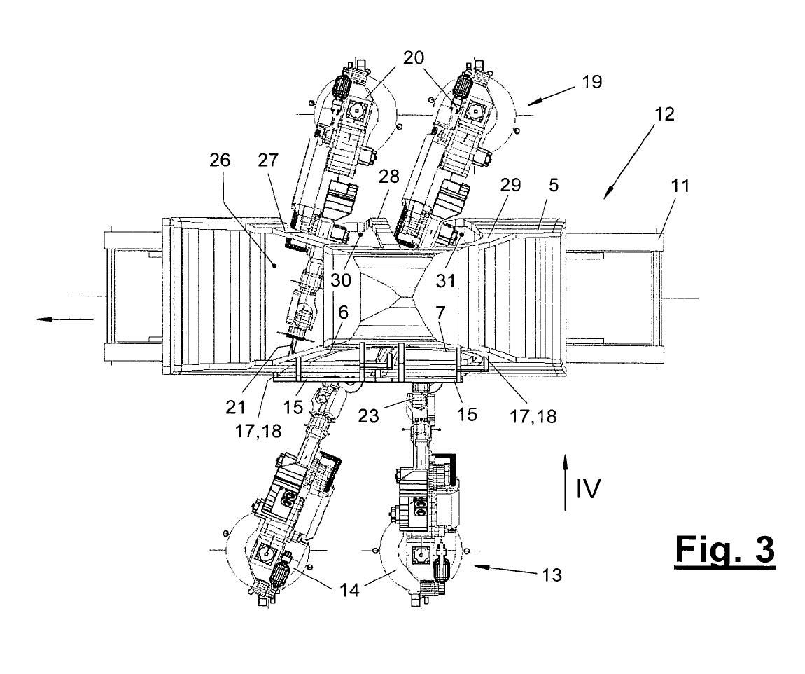

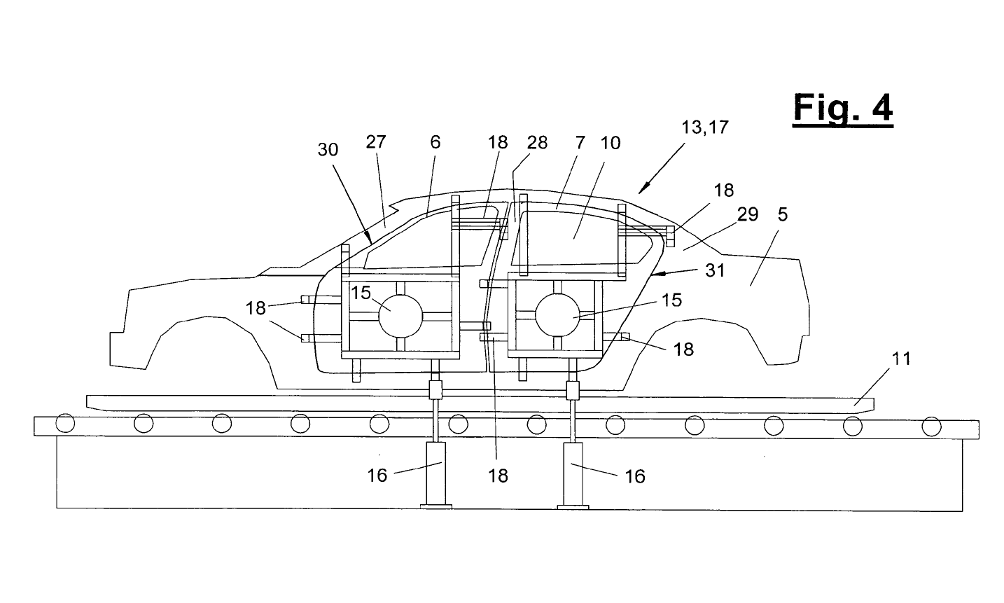

In a schematic top view, FIG. 1 shows a mounting unit (1) for vehicle bodies (5), which are fed on a conveyor (11) along a transfer line and are transported through a plurality of stations (2, 3, 4). The vehicle body (1) is a body shell of vehicles, which comprises at least side walls with cross connections via a roof part and/or an underbody. Other body parts, such as crossrail for the rear shelf, the front wall and the rear wall of the body, etc., may likewise be present. FIGS. 2 and 3 show schematic view of such a vehicle body (5). The vehicle body (5) is intended for an at least four-door vehicle, the side walls having on each side of the vehicle at least two door cutouts (30, 31) for front and rear side doors (6, 7, 8, 9). The embodiment being shown is that of usual limousine forms with two pairs of side doors on left and right. As an alternative, more than two side doors (6, 7, 8, 9) may also be present on each side of the vehicle, which may be the case of, e.g., stretch limos or other special vehicles. The subsequent description pertains to four-door vehicles and can correspondingly also be extrapolated to these special vehicles.

The left and right side doors are mounted side by side and in pairs in the front and rear door cutouts (30, 31) of the vehicle body (5), which cutouts are present on both sides, in two consecutive mounting stations (2, 3). This is preferably the initial mounting, during which the side doors (6, 7, 8, 9) are in the raw form and not yet fitted with all built-in parts. This initial mounting preferably takes place before the painting. After the general painting of the vehicle body (5) and the side doors (6, 7, 8, 9), the side doors are again removed, and the door hinges (34), which will be described in more detail below, are separated, e.g., by pulling out the hinge bolts from the joint (37). The side doors are subsequently fitted with added-on parts and finally mounted again, while the hinge halves are connected again via the inserted hinge bolts. The change in the weight of the finished side doors (6, 7, 8, 9), which is due to the added-on parts mounted later, is taken into account at the time of the initial mounting, and it is also possible to take into account other changes of the doors at the time of the initial mounting as a precaution.

In the variant of the mounting unit shown in FIG. 1, the two front and rear side doors (6, 7) are mounted together on the left side of the vehicle, e.g., in the first mounting station (2). The front and rear side doors (7, 8) are mounted together on the right side of the vehicle in the next mounting station (3). The mounting stations (2, 3) preferably join each other directly in the transfer line. The left/right sequence of mounting may be alternatively transposed. Additional mounting operations, e.g., the attachment of fenders, etc., may take place in additional next stations (4).

In a variant of the embodiment being shown, the two mounting stations (2, 3) can be combined into a single mounting station, in which the front and rear side doors are mounted, one after another and again side by side, at first on one side and then on the other side of the vehicle. Furthermore, it is possible to also mount other body parts, e.g., the above-mentioned fenders, etc., on the vehicle body (5) in the mounting station or mounting stations (2, 3).

According to FIG. 1, the making available and feeding of the front and rear side doors (6, 7, 8, 9) and optionally also the preparation and especially the premounting of these side doors (6, 7, 8, 9) can be performed on both sides of the transfer line. The prepared front and rear side doors (6, 7, 8) are brought together on the necessary side of the vehicle or the mounting side by means of a component feed (24) bridging over the transfer line.

The side doors (6, 7, 8, 9) are preferably fitted with door hinges (34) before the mounting on the vehicle body (5). This may be carried out in a premounting means (25), which may be arranged externally or within the mounting stations (2, 3). The mounting of the hinges will be discussed in more detail later.

A mounting means (12) is present in each mounting station (2, 3) for the mounting of the side doors. This comprises a positioning means (13) each for guiding the side doors (6, 7, 8, 9) and holding same in a correct position for mounting and a fixing means (19) for fixing the side doors (6, 7, 8, 9) and especially the door hinges (34) on the vehicle body (5). The door hinges (34) are mounted now, e.g., on the door pillars (27, 28, 29) and fixed. The vehicle body (5) has, on both sides, an A pillar (27), a middle B pillar (28) and a rear-side C pillar (29).

The positioning means (13) and the fixing means (19) are arranged opposite each other at the transfer line and the vehicle body (5) in the embodiment being shown. The positioning means (13) holds the side door pairs (6, 7) and (8, 9) with a gripping tool (15) in a correctly fitting manner and in a correct position for mounting at the facing side of the vehicle body (5) and position them preferably in a centered and aligned position in the front and rear door cutouts (30, 31).

Fixation is carried out preferably on the inner side of the vehicle and from the interior space (26) of the body. The fixing means (19) may be designed for this purpose with its one or more fixing tools (21) such that it can extend into the interior space (26) of the body and reach the door hinges (34) with its fixing tools. In the arrangement being shown, the fixing means (19) passes in the first mounting station (2) through the still open door cutouts (30, 31) on its side and through the interior space (26) of the body. In the second mounting station (3), the fixing means (19), which is present there and is arranged on the other side of the vehicle, passes through the window cutouts of the side doors (6, 7) already mounted on that side.

The positioning means (13) comprises, e.g., two positioning robots (14), which are preferably designed as multiaxial, especially six-axis articulated arm robots and have a multiaxial robot hand (23). The two positioning robots (14) arranged next to each other carry a gripping tool (15) each, which comprises a frame with controllable grippers arranged thereon corresponding to the geometry of the door. The positioning robots (14) can grip with their gripping tools (15) into the side doors (6, 7, 8, 9) made ready in a predetermined position and move in a mutually coordinated manner.

In a variant, not shown, it is possible to use an individual positioning robot (14) and a combination gripping tool, which can grip, with correspondingly designed gripping tools and with integrated additional axes, two front and rear side doors (6, 7) and (8, 9), respectively, together and move them relative to one another preferably multiaxially in a mutually coordinated manner.

The positioning means (13) is equipped with a measuring and aligning device (17) for the correctly fitting positioning of the side doors (6, 7, 8, 9). This comprises, e.g., a plurality of sensors (18), which may be arranged in a flatly arranged pattern at the gripping tool (15). These may be, e.g., sensors scanning edges and/or distance-measuring sensors, which operate in a contacting or contactless manner. For example, optical sensors, but also all other suitable sensor types described, e.g., even imaging cameras, are possible. The sensors (18) are connected to a control, not shown, for analyzing the measurement results. The measuring and analysis device (17) is connected to the positioning robots (14) and the control thereof and makes possible the coordinated motion thereof for the correctly fitting mounting of the doors.

Optimized course of a gap and mutual optimized alignment of the front and rear side doors (6, 7) and (7, 8) can be achieved by means of this coordinated motion. In addition, the pairs of side doors can be aligned in an optimal manner in relation to the vehicle body (5) and especially the door cutouts (30, 31). Alignment in relation to design lines, e.g., bent edges, at the side wall, is also possible now. In particular, efforts are made to optimize the gaps extending in the visible area on the top side as well as on the front side and the rear side of the side doors (6, 7, 8, 9) in relation to the edges of the door cutouts (30, 31) by the gaps being made of equal size and being kept as small as possible. The necessary tolerance compensation can take place on the underside of the door, where larger visible gaps are less conspicuous. Flush positioning of the upper edges of the doors and the lower edges of the window cutouts (10) can also be taken into account during the mounting of the door. In particular, the side doors (6, 7, 8, 9) can be centered in their door cutouts (30, 31) and correspondingly displaced and aligned. Transverse tilting of the side doors (6, 7, 8, 9) by the correspondingly mobile positioning robot (14) may also take place to apply a possibly desired prestress to the door. In addition, an allowance may be taken into account at the time of the positioning of the door in order to preventively compensate the heavier weight of the door after the finishing of the door. Possible changes in the shape of the side doors (6, 7, 8, 9) as a consequence of the later outfitting with components can also be taken into account at the time of the initial mounting.

On the one hand, the side doors (6, 7, 8, 9) with their relevant parts and especially their contours can be measured in the outer outline and in the window cutout (10) with the sensors (18). For example, representative edges or other parts of the door are detected now and their actual position is measured. Furthermore, the door cutouts (30, 31) can be measured with the sensors (18) correspondingly in terms of their actual dimensions and their actual position in space. Based on these measured values, the correctly fitting alignment of the door and centering can take place on the basis of these measured values. The positioning robots (14) hold with their gripping tools (15) the side door pairs (6, 7) and (8, 9), respectively, for fixation in a closed position that is correct for mounting in the door cutouts (30, 31), and possible prestresses, allowances or the like can be taken into account in the above-mentioned manner. The gripping tools (15) may be supported for the subsequent fixation by mobile torque supports (16), e.g., bottom-side support props extensible in a controlled manner, for relieving the robots and for absorbing the forces of reaction developing during the fixation. The actuation and positioning of the torque supports (16) takes place via the measuring and aligning device (17). As an alternative, the positioning robots (14) can perform controlled compensating motions to absorb the forces of reaction.

The fixing means (19) comprises in the embodiment being shown two fixing robots (20), which are arranged next to each other on the other side of the vehicle opposite the positioning robots (14). The fixing robots (20) are likewise designed as multiaxial articulated arm robots with a robot hand (23) for the multiaxial guiding of the fixing tools (21) attached here. The fixing tools may be, e.g., screwing tools or welding tools or the like.

In a variant of the embodiment being shown, the fixing robots (24) may be arranged above the transfer line and designed, e.g., as portal robots. The fixing robots (20) may also reach with their robot arms and the robot hand (23) into the interior space (26) of the body through the front-side and rear-side window cutout. In addition, it is also possible to arrange the fixing robots (20) provided with a corresponding range on the same side and next to the positioning robots (14), the access to the inner side of the vehicle being again granted via the front window and the rear window.

The side doors (6, 7, 8, 9) are positioned with premounted door hinges (34) aligned in a correct position for mounting and fixed during the mounting. The hinges are mounted here, e.g., on the outer side (31) of the door pillars (27, 28, 29), the site of fixation in the interior space of the pillar being able to be reached via one or more passage openings (39) on the inner side (32) of the pillar. Suitable fixing elements (38), e.g., screws, can be introduced through these passage openings (39) with the fixing tools (21) or in another manner and activated.

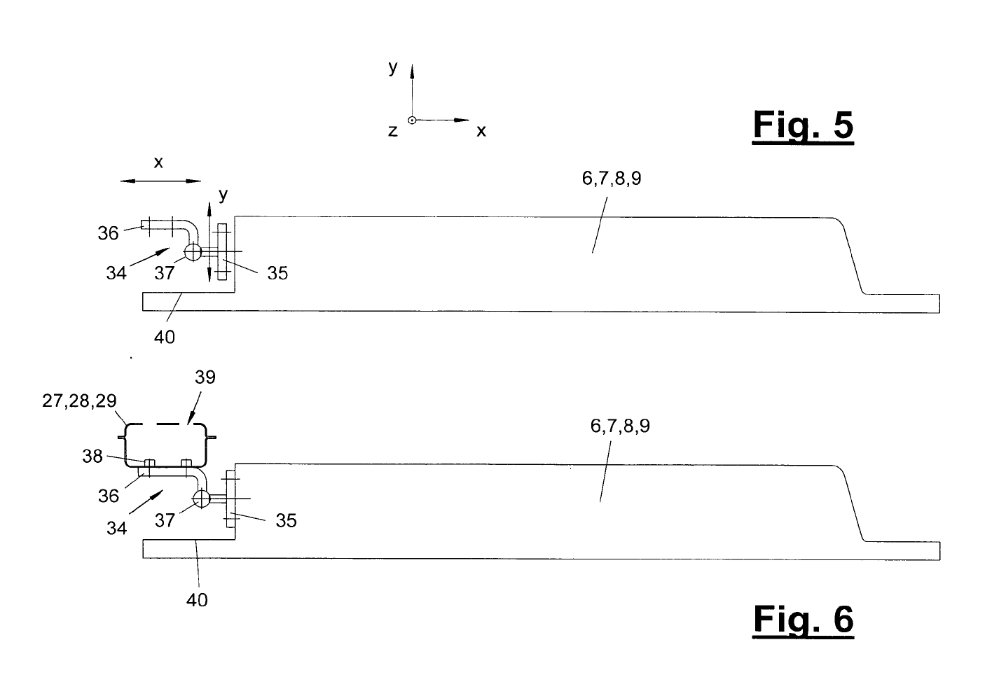

When fixing the hinges on the door pillar (27, 28, 29), any tolerances in the X and Y directions can be compensated, as this is indicated, e.g., in FIG. 5. For example, cage nuts, which are held biaxially movably in a sheet metal bracket at the door hinge (34) and are pulled and screwed into the correct screwing position with a centering pin, may be used as fixing elements for this. The fixing tool (21) may be designed for this purpose as a floating screwdriver. As an alternative, tolerance compensation can be brought about by means of the weld seam in case the door hinge (34) is welded.

As is illustrated in FIGS. 5 and 6, the door hinge (34) has a central joint (37) with the aforementioned hinge bolt and two hinge flanges (35, 36), which are connected movably here. The hinge flanges (35, 36) have a bent shape, and, e.g., the door-side hinge flange (35) has a T-shaped cross section and has a flat flange plate with a connection web jutting out herefrom to the joint (37). The pillar-side hinge flange (36) is designed, e.g., as a hinge plate bent in an L-shaped pattern in the cross section. For fixation to the door pillar (27, 28, 29) or another part of the door cutout (30, 31), the pillar-side hinge flange (36) can be brought during premounting on the side door (6, 7, 8, 9) into an angular position that is correct for mounting and temporarily fixed in a suitable manner. As is illustrated in FIGS. 5 and 6, the hinge flanges (35, 36) are essentially at right angles to one another in the closed position of the side doors (6, 7, 8, 9). The side door (6, 7, 8, 9) has a correspondingly shaped and sufficiently large door rabbet (40) for this.

Tolerances along the translatory X, Y and Z axes as well as optionally also along the rotatory axes are to be taken into account at the time of the mounting of the door. For example, the door-side hinge flange (35) has a flat design for the translatory tolerance compensation. The tolerance is compensated by elongated holes or the like in the Y direction. These tolerances in the Y direction can be determined during the premounting of the door hinge (14) and compensated at the time of the fastening of the hinge. The tolerances in the X and Z directions are compensated in the above-mentioned manner by the fastening or fixation of the body-side hinge flange (36). For example, oversized holes can be used for this, e.g., for a screw connection.

By measuring the door during and after mounting, which is carried out, e.g., with the measuring and aligning device (17) or in another manner, it can be determined whether the tolerances were compensated correctly and sufficiently during the mounting of the hinge. Should there be, e.g., any changes on the door pillar (27, 28, 29), which lead to a change in the mounting of the hinge in the Y direction, this can be determined by calculation, evaluated, and compensated in the next doors in a preventive manner by a corresponding feedback and control of the premounting on the side door. Statistical survey and analysis of the measurement results can be carried out for this in order to make it possible to detect possible trends in the changes in the shape of the vehicle body (5) in time and in a purposeful manner and compensate them correspondingly.

Various variants of the embodiments shown and described are possible. The door may be fixed, in case of a suitable design of the door, from the outside and without reaching into the interior space (26) of the body, and the cooperating positioning and fixing means (13, 19) are arranged on the same side of the vehicle. All side doors (6, 7, 8, 9) may also be mounted and fixed simultaneously. The inner fixation of the side doors (6, 7, 8, 9) being claimed can also be carried out, on the other hand, with conventional mounting techniques and in case of individual mounting of the doors. Thus, it has an independent inventive significance. Furthermore, the design embodiment of the mounting means (12) and the components thereof, and, on the other hand, also the shape of the vehicle body (5) and parts thereof as well as of the door hinges (34) may be modified as well. The mounting unit (1) may otherwise have any desired and suitable design.

While specific embodiments of the invention have been shown and described in detail to illustrate the application of the principles of the invention, it will be understood that the invention may be embodied otherwise without departing from such principles.

1-21. (canceled)

22. A mounting unit for mounting at least four side doors on a vehicle body with door cutouts, the mounting unit comprising:
a mounting station mounting a plurality of the side doors to the vehicle body via a hinge connection, said mounting station mounting at least one side door on each side of the vehicle;
a mounting mechanism including a positioning means with a measuring and aligning device for positioning each of said side doors on the vehicle body and a fixing means for fixing each door to the vehicle body, said mounting mechanism being arranged in said mounting station.

23. A mounting unit in accordance with claim 22, wherein said positioning means is arranged on one side of the vehicle body and said fixing means is arranged adjacent to said positioning means or said fixing means is arranged on another side of the vehicle body, opposite said positioning means, said fixing means being movable such that a portion of said fixing means extends within an interior space of the vehicle body to an inner side location of the vehicle body, said fixing means fixing each of the side doors at said inner side location of the vehicle body.

24. A mounting unit in accordance with claim 22, wherein a plurality of said mounting stations are located adjacent to each other, one mounting station having said positioning means located on a first side of the vehicle body and a fixing means located on a second side of the vehicle body, said first side being opposite said second side, another mounting station having said positioning means located on said second side of the vehicle body and said fixing means located on said first side of the vehicle body.

25. A mounting unit in accordance with claim 22, wherein said mounting means mounts the side doors in a closed position in the door cutouts.

26. A mounting unit in accordance with claim 22, wherein said positioning means has at least two positioning robots connected to said measuring and aligning device, each positioning robot having a gripping tool for gripping one of the side doors.

27. A mounting unit in accordance with claim 22, wherein said positioning means has a positioning robot, said positioning robot having a combination gripping tool with additional arms for independently holding and moving a plurality of said side doors, said additional arms being connected to said measuring and aligning device.

28. A mounting unit in accordance with claim 27, wherein said measuring and aligning device has a plurality of sensors arranged on said gripping tool for measuring actual position and dimensions of the side doors and of the door cutouts of the vehicle body, said measuring and aligning device having a control element for aligning one side door with another side door relative to the door cutouts.

29. A mounting unit in accordance with claim 27, wherein said positioning means has at least one torque support, said measuring and aligning device controlling said at least one torque support such that said at least one torque support supports said gripping tool.

30. A mounting unit in accordance with claim 22, wherein said fixing means has one or more fixing robots, each fixing robot having one or more fixing tools.

31. A mounting unit in accordance with claim 30, wherein said one or more fixing tools comprise screwing or welding tools.

32. A mounting unit in accordance with claim 22, wherein said positioning means comprises one or more positioning robots, said fixing means comprising one or more fixing robots, said positioning robots and said fixing robots comprising multi-axial articulated-arm robots, each multi-axial articulated-arm having a multi-axial robot hand.

33. A mounting unit in accordance with claim 22, further comprising one or more pre-mounting means for mounting door hinges on the side doors.

34. A mounting unit in accordance with claim 33, wherein at least one of said door hinges is positioned at one of the side doors during pre-mounting of one of the side doors in a Y direction.

35. A mounting unit in accordance with claim 33, wherein at least one of said door hinges is positioned at the door cutout of one of the side doors during mounting of one of the side doors in the X and Z directions.

36. A mounting unit in accordance with claim 33, wherein at least one of said door hinges is fastened to an outside surface of a door pillar during mounting of one of the side doors.

37. A mounting unit in accordance with claim 36, wherein said door pillar has at least one passage opening on an inner side thereof for receiving a fixing means.

38. Amounting unit in accordance with claim 22, wherein said hinge connection has a joint and two bent hinge flanges.

39. A mounting unit in accordance with claim 38, wherein each side door has a door rabbet for receiving said hinge flanges, one bent hinge flange being substantially perpendicular to another bent hinge flange in a closed position.

40. A process for mounting a least four side doors on a vehicle body with door cutouts, the process comprising:
mounting a plurality of side doors together on one side of the vehicle body in a mounting station;
holding said side doors together;
providing a positioning means with a measuring and aligning device;
measuring each side door and detecting position of each side door with said measuring and aligning device to provide a plurality of side door data;
moving said side doors with said positioning means based on said side door data;
fixing said side doors with a fixing means.

41. A mounting process in accordance with claim 40, wherein said plurality of side doors includes a first front side door, a first rear side door, a second front side door and a second rear side door, said first front side door and said first rear side door being mounted on one side of the vehicle body, said second front side door and said second rear side door being mounted on another side of the vehicle body after said first front side door and said first rear side door have been mounted to the vehicle body.

42. A mounting process in accordance with claim 40, wherein said fixing means is arranged adjacent to said positioning means on one side of the vehicle body or said fixing means is arranged on another side of the vehicle body, opposite said positioning means, said fixing means being movable such that a portion of said fixing means extends within an interior space of the vehicle body to an inner side location of the vehicle body, each of the side doors being fixed to the vehicle body when said fixing means is at said inner side location of the vehicle body.
